(19) United States
(12) Patent Application Publication
(10) Pub. No.: US 2011/0284594 A1
(43) Pub. Date: Nov. 24, 2011

(54) CONTINUOUS DISPENSING SPRAY ACTUATOR

(75) Inventors: David A. Dupont, Allenstown, NH (US); Brian McDonald, Manchester, NH (US)

(73) Assignee: Summit Packaging Systems, Inc., Manchester, NH (US)

(21) Appl. No.: 12/786,035

(22) Filed: May 24, 2010

(51) Int. Cl. B65D 83/00; B67B 1/00

(52) U.S. Cl. 222/402.14; 222/153.12

(57) ABSTRACT

A continuous dispensing actuator assembly having a mounting cup, an actuator, an overcap and a locking adaptor provides for automatic discharge of the contents of a pressurized container. The mounting cup secures to an open end of the pressurized container and has a valve biased into a normally extended closed position with an extending valve stem. The overcap includes a base portion affixed to the mounting cup, an orientation tab slidably residing within the slot in the actuator to prevent rotational movement of the actuator, a locking mechanism and a slot in the locking mechanism sized to allow passage of the actuator cam post.

### FIELD OF THE INVENTION

The present invention relates to a combined actuator/overcap assembly for an aerosol product, and more specifically relates to an actuator which can be locked, in a dispensing position, to facilitate continuous dispensing of the product contents of an aerosol container when actuated by an operator via rotation of the assembly between an inactive position and an active position.

### BACKGROUND OF THE INVENTION

There are a variety of prior art dispensing systems that are currently available in the marketplace. Many of these systems are designed for intermittent discharge of product contents and are suitable for such applications. However, there are some applications where a continuous dispensing of the entire product contents or a substantial portion of the product contents, of an aerosol or other pressurized container is desired by an operator. When continuous dispensing of the entire product contents is desired, it is tedious and cumbersome for the operator to depress continuously the actuator of the aerosol container to facilitate dispensing of the desired quantity of the product contents.

Various arrangements to provide aerosol locking devices have been known in the art, for example U.S. Pat. No. 4,195,756 which describes various latching and locking arrangements which will latch the aerosol valve in the open position. Each of the devices described in the '756 patent has particular disadvantages. Many of the locking arrangements are more appropriate to the discharge of a mist or vapor from a container to fill a room, such as a fumigant. Also U.S. Pat. No. 6,062,432 discloses an actuator cap which merely describes a pin which is locked in position to actuate a valve by a body portion when the pin is depressed. No further description of how the pin, valve and body portion lock or interact is however provided by this reference.

These known continuous dispensing systems which lock the actuator in a depressed position can be cumbersome to engage, resulting in poor initial spray control. Additionally, locked actuators of this type which interact with the valve in the aerosol can often cannot be readily unlocked if complete discharge of the container contents is not necessary.

### OBJECT AND SUMMARY OF THE INVENTION

Wherefore, it is an object of the present invention to overcome the aforementioned problems and drawbacks associated with the dispensing systems currently known in the prior art.

Another object of the invention is to provide an actuator assembly which can be locked in a continuous dispensing position to facilitate dispensing of the entire contents of the aerosol container, or a substantial portion thereof, without an operator having to continuously depress the actuator.

A further object of the present invention is to provide an actuator assembly which converts rotational movement of the assembly by a user to reciprocating motion of the actuator between open and closed valve conditions.

Still another object of the invention is to allow a continuous dispensing of an aerosol container to be interrupted, as desired, by rotation of the assembly, in a convenient and simple manner, which shuts off the flow of the aerosol contents through the valve coupled to the actuator.

Yet another object of the invention is to provide an actuator dispensing assembly which is relatively inexpensive to manufacture, is lightweight and durable, and can be readily mass produced.

The present invention relates to a continuous dispensing actuator assembly for a pressurized container comprising an actuator having a stem seat adapted to receive a valve stem of a valve, a discharge outlet in fluid communication with the stem seat and a cam post; an overcap having a base portion for engagement with a mounting cup of the pressurized container on a lower surface and a lock ring adaptor on an upper surface of the overcap; a lock ring rotatably received by the lock ring adaptor and an integral control tab for rotating the lock ring about the lock ring adaptor, and a cam surface on the lock ring adapted to engage the cam post to cause axial reciprocation of the actuator between an open and a closed positions.

The present invention further relates to a pressurized container including a continuous dispensing actuator assembly comprising an actuator having a stem seat for receiving a valve stem of a valve, a discharge outlet in fluid communication with the stem seat, a cam post and rotational control means for maintaining the actuator in a rotationally fixed position relative to the valve stem, an overcap having a lock ring adaptor including an annular wall with a lip for retaining a lock ring sized to fit around the annular wall and an opening sized to allow passage of the actuator at least partially through the overcap, and wherein the lock ring is rotatably secured to the lock ring adaptor and a cam surface on the lock ring is adapted to engage the actuator cam post to reciprocate the actuator in an axial manner relative to the valve stem.

The present invention also relates to a continuous dispensing actuator assembly for a pressurized container comprising an actuator having a stem seat for receiving a valve stem of a valve, a discharge outlet in fluid communication with the stem seat, a cam post and control means for maintaining the actuator in a fixed position relative to the valve stem, an overcap having a radial passage to allow passage of a lock button at least partially through the overcap and a spring tab biasing the lock button in a closed position, the lock button having an aperture with a cam surface to allow passage of the actuator at least partially through the lock button; and wherein the cam surface of the lock button is adapted to engage the actuator cam post to reciprocate the actuator in an axial manner relative to the valve stem.

The present invention also relates to a method of dispensing pressurized fluids from a pressurized container comprising the steps of providing an actuator having a stem seat adapted to receive a valve stem of a valve, a discharge outlet in fluid communication with the stem seat and a cam post; forming an overcap having a base portion for engagement with a mounting cup of the pressurized container on a lower surface and a lock ring adaptor on an upper surface of the overcap; attaching a lock ring rotatably received by the lock ring adaptor on the overcap, and forming a cam surface on the lock ring adapted to engage the cam post to cause axial reciprocation of the actuator between an open and a closed positions.

The present invention also relates to a method of dispensing pressurized fluids from a pressurized container comprising the steps of providing an actuator having a stem seat adapted to receive a valve stem of a valve, a discharge outlet in fluid communication with the stem seat and a cam post; forming an overcap having a base portion for engagement with a mounting cup of the pressurized container on a lower surface and a passage for accepting a lock button; inserting the lock button through the passage in the overcap, the lock button having an aperture and a cam surface; inserting the actuator through the aperture of the lock button; and actuating the lock button to engage the cam post to cause axial reciprocation of the actuator to an open continuous spray position.

The present invention further relates to a pressurized container in combination with a continuous dispensing actuator assembly, the pressurized container being a closed container which is sealed by a mounting cup accommodating a normally closed valve therein, and to methods of making and using the invention.

These and other features, advantages and improvements according to this invention will be better understood by reference to the following detailed description and accompanying drawings.

### BRIEF DESCRIPTION OF THE DRAWINGS

The invention will now be described, by way of example, with reference to the accompanying drawings in which:

FIGS. 1A and 1B are exploded views of a first embodiment of the continuous dispensing actuator assembly according to the present invention;

FIG. 2A is an enlarged perspective view of the mounting cup shown in FIGS. 1A and 1B;

FIG. 2B is a perspective view of the mounting cup of the prior art;

FIG. 3 is an enlarged perspective view of the actuator shown in FIGS. 1A and 1B;

FIG. 4 is an enlarged perspective view of the overcap shown in FIGS. 1A and 1B;

FIG. 5 is an enlarged perspective view of the lock ring shown in FIGS. 1A and 1B; and

FIGS. 6A and 6B are perspective views of the assembled continuous dispensing actuator assembly shown in FIGS. 1A and 1B;

FIG. 7 is a cross-section of the first embodiment of the continuous dispensing actuator assembly according to the present invention.

FIGS. 8A-D are perspective views of a second embodiment of the present invention showing a lock button and actuator button in relative on and off positions;

FIGS. 9A-B are exploded views of the actuator according to the second embodiment;

FIGS. 9C-D are exploded view of the actuator according to the second embodiment; and

FIGS. 10A-C are related perspective, planar and cross-section views of the second embodiment of the lock button of the present invention.

### DETAILED DESCRIPTION OF THE INVENTION

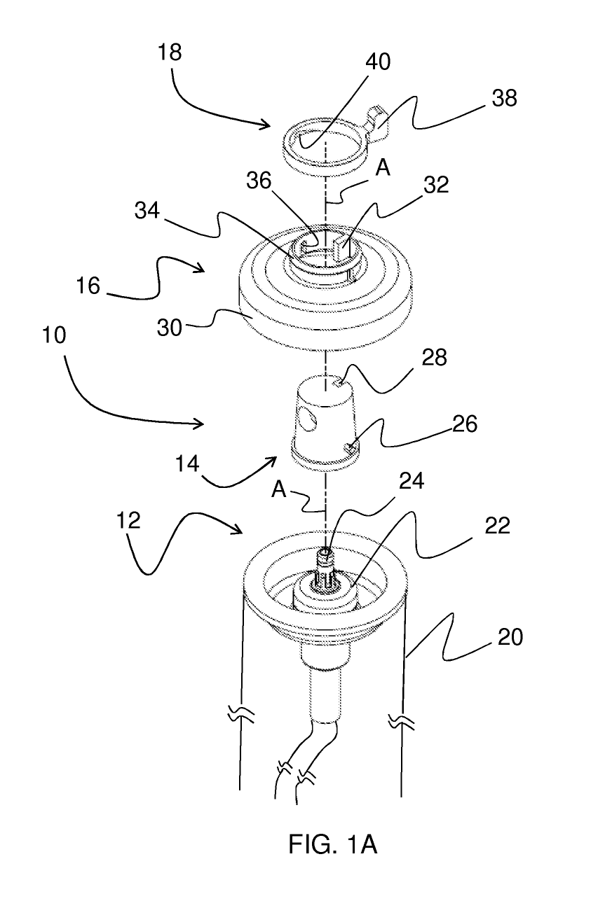

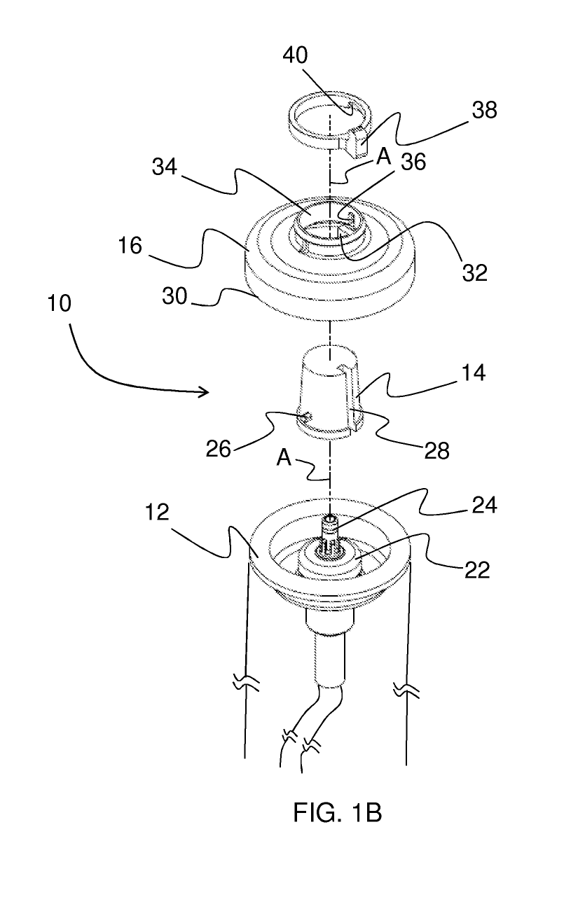

Turning initially to FIGS. 1A and 1B, the present invention relates to a continuous dispensing actuator assembly 10 for mounting engagement with a mounting cup 12 of a container 20, for example an aerosol container containing a pressurized product. The actuator assembly includes an actuator 14, an overcap 16 and a lock ring 18 which cooperatively provide for automatic discharge of the contents of the pressurized container 20.

The mounting cup 12 seals shut an open end of the pressurized container 20 as is well known in the art and supports a valve 22 biased into a normally closed position with a valve stem 24 extending along a main axis A through an opening in the mounting cup 12. The actuator 14 has a stem seat for mounting the actuator 14 onto the valve stem 24, at least a cam post 26 extending radially outwardly relative to the axis A and a lengthwise slot 28 in an outside surface of the actuator 14. The overcap 16 includes a base portion 30 to be affixed to the mounting cup 12, an orientation tab 32 to be slidably received within the slot 28 in the actuator 14 to prevent rotational movement of the actuator 14, a lock ring adaptor 34, and a slot 36 defined in the wall of the lock ring adaptor 34 sized to allow entry of the actuator cam post 26. The body of the lock ring 18 rotatably affixes about the lock ring adaptor 34 and has a control tab 38 for gripping and rotating the lock ring 18. A camming surface 40 is provided on an inside wall of the lock ring 18 which engages the actuator cam post 26 as described in further detail below.

The lock ring 18, actuator 14 and overcap 16 together restrict rotational movement of the actuator 14 while allowing up/down reciprocating motion. The camming surface 40 of the lock ring 18 engages the actuator cam post 26 and converts rotational movement of the lock ring 18 into reciprocating axial motion of the actuator 14, from an off position with the valve closed to an on position with the valve open for continuous discharge of the container 20 contents.

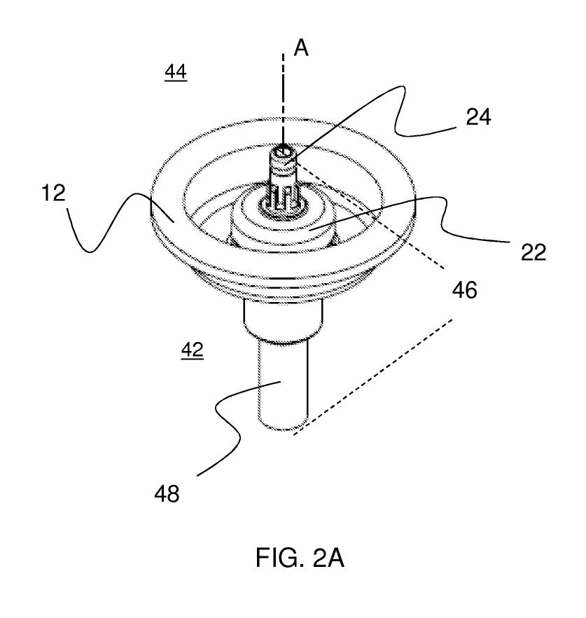

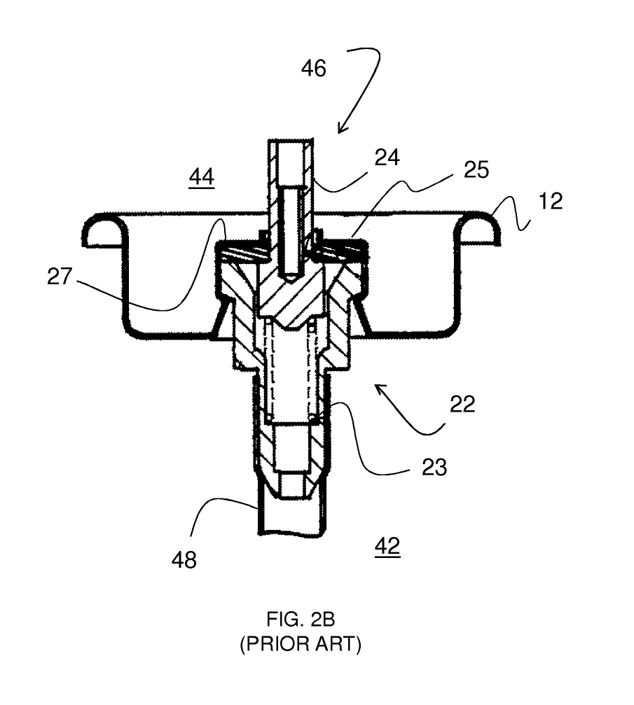

With reference to FIGS. 2A-B, the mounting cup 12 secures and seals shut an open end of a pressurized container 20. The mounting cup 12 has oppositely disposed sides, a containment side 42 adapted to secure to the container 20 and a discharge side 44. A valve assembly 46 is contained in the mounting cup 12, for example through a central aperture, and extends from the containment side 42 to the discharge side 44 of the mounting cup 12. The valve assembly 46 has a valve stem 24 extending from the discharge side 44 of the mounting cup 12, a product inlet or dip tube 48 on the containment side 42 of the mounting cup 12, and a valve 22 interconnecting the valve stem 24 and the product inlet 48, the valve 22 being biased into a normally closed position by a spring 23. In general, the valve stem 24 is upwardly biased in an extended position with the valve 22 being closed. Depressing the valve stem 24 sufficiently to overcome the upward bias provided by the spring 23 opens the valve 22 by permitting fluid flow through a radial orifice 25 which is normally blocked by resilient seal 27, allowing product dispensing from the dip tube 48 through the valve 22 and up and out of the valve assembly 46 through the valve stem 24. As such aerosol valves are generally known in the art, no further description is provided.

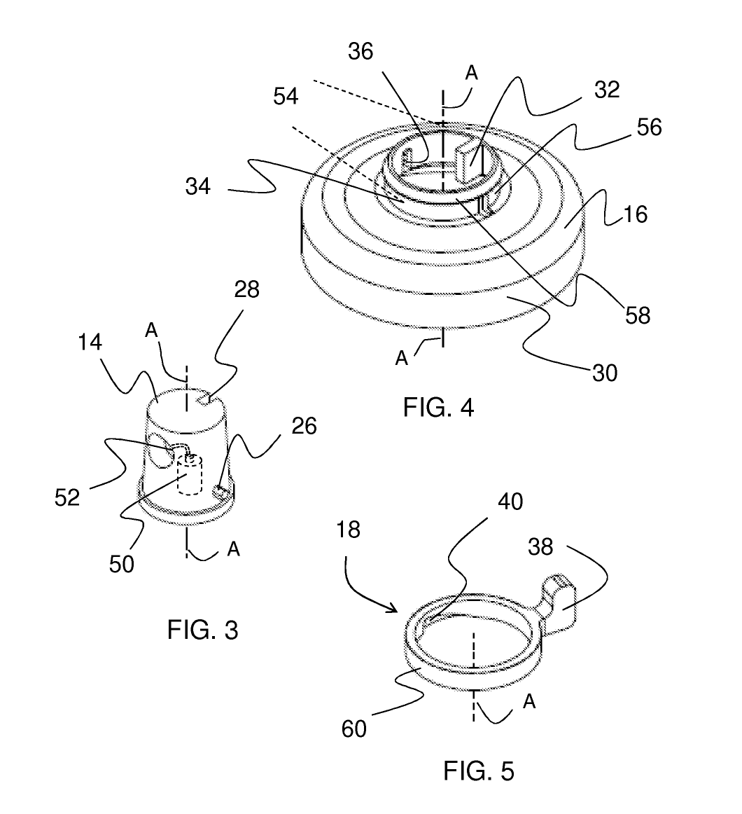

The actuator 14 which mounts to the valve stem 24 is illustrated in FIG. 3. The bottom of the actuator 14 has a recessed stem seat 50 defining a passage along axis A for receiving the valve stem 24, a discharge outlet 52 in fluid communication with the stem seat 50, an outwardly extending cam post 26 and an orientation slot 28. As the orientation slot 28 functions to restrict rotational movement by the actuator 14, the slot 28 will generally be parallel with the valve stem 24 along axis A. When the actuator 14 is depressed axially along axis A, the valve stem 24 is likewise depressed, which opens the valve 22 to discharge the contents of the container 20 through the valve stem 24 and the actuator 14, then out through the discharge outlet 52.

As shown in FIG. 4, the overcap 16 includes the base portion 30 which engages the perimeter of the discharge side of the mounting cup 12 and the lock ring adaptor 34 receives in the opening the actuator 14 and assists in controlling actuator movement. The lock ring adaptor 34 of the overcap 16 has on an inner wall thereof an orientation tab 32 adapted to slidably reside within the orientation slot 28 in the actuator. The lock ring adaptor 34 rotatably retains the lock ring 18 about an outer wall of the adaptor 34, and also includes slot 36 sized to allow passage of the actuator cam post 26 through the lock ring adaptor 34. Shown in FIG. 4 is an embodiment of the invention wherein the lock ring adaptor 34 comprises an annular ring 56 having a lip 58 for retaining the lock ring 18.

FIG. 5 illustrates the lock ring 18 of the present invention. The lock ring 18 has a lock ring body 60 which is rotatably received on the lock ring adaptor 34, a control tab 38 for gripping the lock ring 18 during rotation extends radially from the ring 18, and a camming surface 40 formed on the inner surface of the ring 18 is adapted to engage the actuator cam post 26 to reciprocate the actuator between an off position with the valve is closed or blocked and an on position with the valve open, when the lock ring 18 is rotated. The camming surface 40 is preferably formed as a cavity in an inside surface of the lock ring body 60, as shown in FIG. 5.

FIGS. 3-5 show the relationship between the different components of the actuator 14, the overcap 16 and the lock ring 18. The lock ring 18 is rotatably retained to the lock ring adaptor 34 of the overcap 16. Speaking generally, in order to provide rotation of the lock ring 18 relative to the overcap 16, the lock ring adaptor 34 will preferably include an annular ring 56 extending from the surface of the overcap 16. The lock ring 18 has a lock ring body 60 sized to fit closely over the annular ring 56. A lip 58 around a top edge of the annular ring 56 is slightly larger than the inner diameter of the lock ring 18 and thus rotatably retains the lock ring 18 to the overcap 16 when the lock ring body 60 is pressed onto the lock ring adaptor 34.

The lock ring 18 includes the camming surface 40 which engages the actuator cam post 26 which extends through the slots 36 in the lock ring adaptor 34 to urge reciprocation of the actuator 14, upon rotation of the lock ring 18, from an off position with the valve closed and blocked to an on position with the valve open for continuous spray. Due to the vertical, axial nature of the slots 36 the cam posts 26 can only influence the actuator 14 in an axial path along axis A when the actuator 14 is set in the overcap 16.

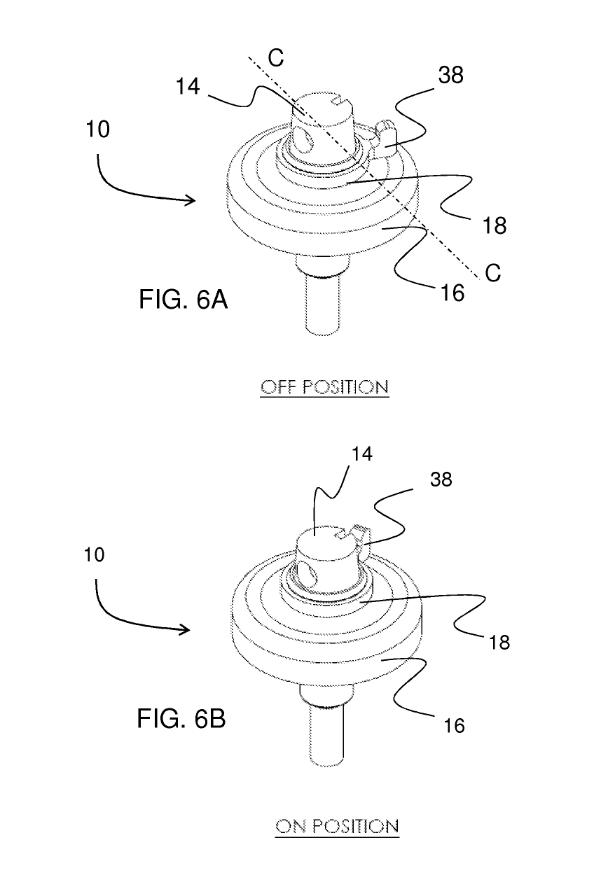

FIGS. 6A and 6B illustrate the continuous dispensing actuator assembly 10 in a fully assembled orientation. FIG. 6A shows the assembly 10 in an “off” position, that is, the actuator 14 is extended (not depressed) which maintains the valve in a closed position. In FIG. 6B, the lock ring 18 has been rotated relative to the overcap 16. The actuator 14, however, is blocked from relative rotation by the orientation tab 32 on the overcap 16 residing within the orientation slot 28 in the actuator 14. As the lock ring 18 is rotated, generally by a user grasping the control tab 38, the camming surface 40 on the lock ring 18 engages the cam post 26 on the actuator 14, converting the rotational motion of the lock ring 18 into a reciprocating, up/down, motion of the actuator 14. As best illustrated in FIGS. 3-5, the camming surface 40 of the lock ring 18 is adapted to engage the cam post 26 on the actuator 14. Because the camming surface 40, generally an inclined plane, can be a shallow or steep gradient, great control can be maintained over the degree of mechanical advantage provided by the camming surface 40. A non-inclined portion 62 at the end of the camming surface 40 assists to retain the actuator 14 in a depressed condition for continuous discharge of the contents of the container. Accordingly, the continuous dispensing actuator assembly 10 of the present invention can have various orientations. For example, in one embodiment of the invention the combination of one or more of steep camming surfaces, low friction cam surfaces, and no level portion at the end of the camming surface 40 results in a valve wherein the valve's upward bias is sufficient to rotate the lock ring 18 back to an off position when the lock ring 18 is released by the user during discharge.

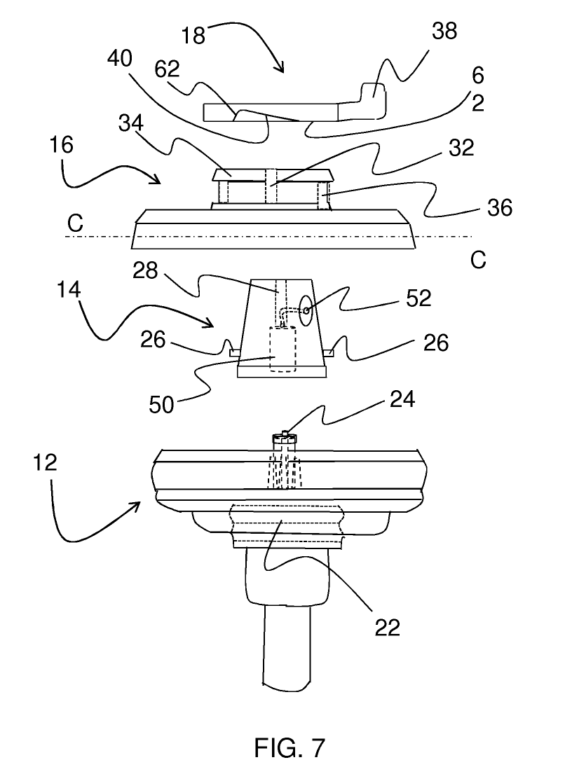

The continuous dispensing actuator assembly 10 of the present invention is assembled as illustrated in FIG. 7. The mounting cup 12 is connected to the actuator 14 by seating the valve stem 24 in the stem seat 50 in the bottom of the actuator 14. The overcap 16 connects to the mounting cup 12, with the actuator 14 extending through the lock ring adaptor 34 and the actuator cam post 26 extending through the slot 36 in the lock ring adaptor 34. Additionally, the overcap 16 is affixed to the mounting cup 12 such that the orientation tab 32 on the controller portion 54 of the overcap 16 resides within the orientation slot 28 in the actuator 14. With the overcap 16 thus properly affixed to the mounting cup 12, the orientation tab 32 prevents relative rotational motion of the actuator 14, while allowing the actuator 14 to be depressed in order to open the valve and discharge the contents of the pressurized container 20. As seen here in FIG. 7, the actuator 14 may include a pair of generally oppositely disposed cam posts 26, with the lock ring 18 having a pair of likewise oppositely disposed camming surfaces 40.

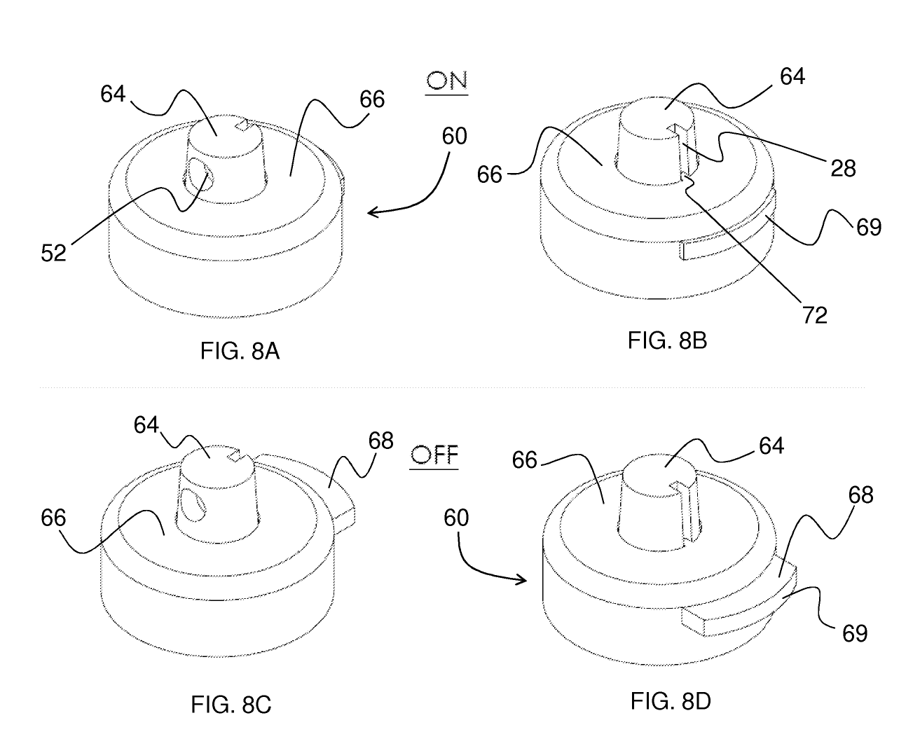

In a further embodiment of the present invention shown in FIGS. 8-10, an actuator assembly 60 includes an actuator 64 moveably supported and engaged in an overcap 66 in conjunction with a radially mounted lock button 68 to operate and maintain the actuator 64 in a continuous spray position. As shown for example in FIGS. 8C-D.

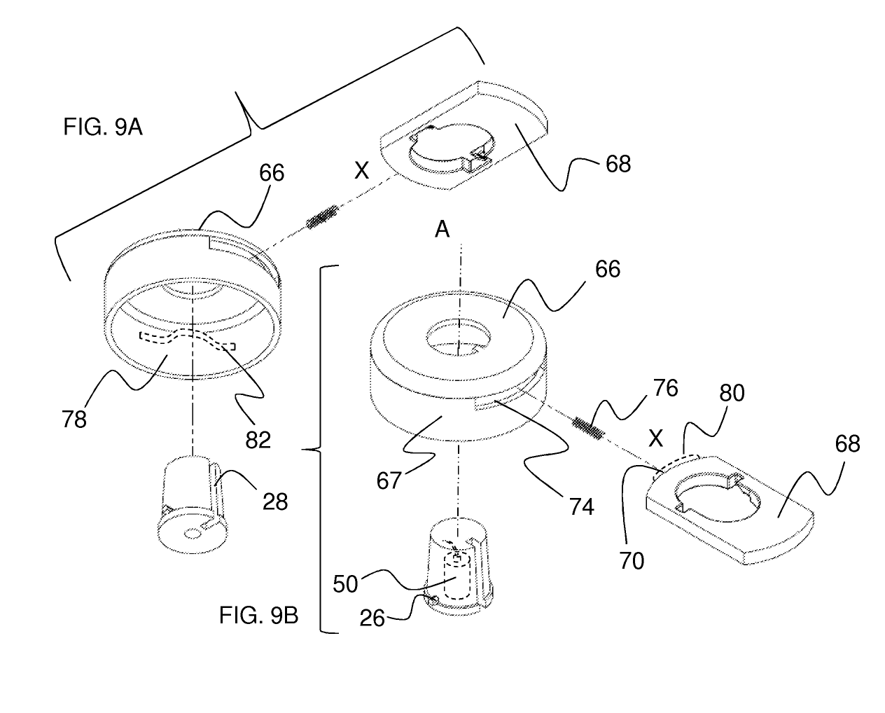

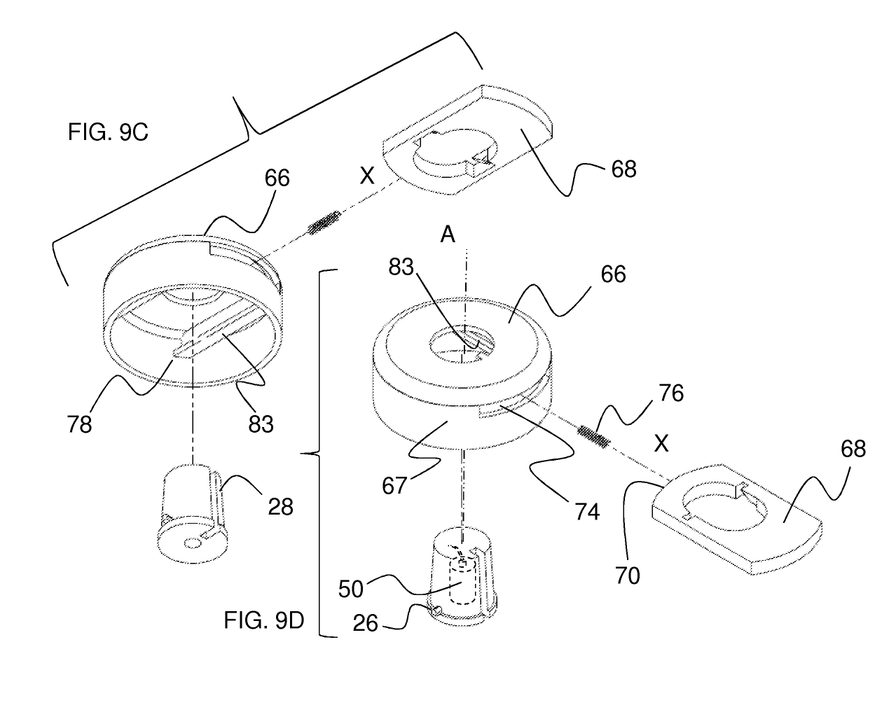

The actuator 64 is similar to that described in previous embodiments which mounts to the valve stem 24 as illustrated in FIGS. 9A-B and maintains the actuator and valve in a continuously dispensing state when actuated by a user. Like actuator 14, the bottom of actuator 64 has a recessed stem seat 50 defining a passage along axis A for receiving the valve stem 24, a discharge outlet 52 in fluid communication with the stem seat 50, an outwardly extending cam post 26 and an orientation slot 28. As the orientation slot 28 functions to restrict rotational movement by the actuator 14, the slot 28 will generally be substantially axially aligned with the valve stem 24 along axis A, although some deviation based on the slightly tapered shape of the actuator 64 could be expected. It is to be appreciated that two cam posts 26 are provided on opposing sides of the actuator 64. Generally, when the actuator 64 is depressed axially along axis A, the valve stem 24 is likewise depressed, which opens the valve 22 to discharge the contents of the container 20 through the valve stem 24 and the actuator 14, then out through the discharge outlet 52.

The overcap button housing 66 is supported on and affixed to the mounting cup 12 as described above with respect to the previous embodiments. The button housing 66, like overcap 16 of the previous embodiments, is provided with an orientation tab 72 to be slidably engaged within the slot 28 in the actuator 64 to prevent rotational movement of the actuator 64 relative to the overcap 66. The slot 28 and tab 72 could also be on the opposite structure. In the present embodiment the button housing 66 is also provided with a radial passage 74 through the side wall 67 of the button housing 66 to receive the lock button 68.

The lock button 68 has a non-actuated, or “off”, position as shown in FIGS. 8C and 8D where an extending end portion indicates that the lock button 68 is influenced radially outwards from the actuator axis into the disengaged position by a spring 76 as discussed in detail below. As seen in FIGS. 8A and 8B, where the actuator assembly is in an actuated “on” position and dispensing product from the container through the valve and out of the actuator 64, the actuator 64 has been axially depressed relative to the button housing 66 and an inner end of the lock button 68 is now influenced against a spring bias radially inwards toward the valve along the axis X. FIGS. 8A-B show two different perspectives of the lock button 68 in the actuated position where the lock button 68 has been radially pushed in by the user, or has been influenced inwards by a user pressing axially down on the actuator 64. In either event, the actuator 64 is influenced downwards axially against the valve stem to release the product from the container in a continuous spray.

Turning to FIGS. 9A-B the actuator assembly 60 of the present embodiment is shown in exploded view whereby the lock button 68 and a biasing spring 76 are shown as they are intended to be assembled and inserted into the button housing 66. Besides the actuator 64, button housing 66 and lock button 68, the spring 76 is shown in its relative position between the button housing 66 and the lock button 68. As can be appreciated the coil spring 76 as shown creates a radial bias between the inner sidewall 78 of the button housing 66 and the inner end 70 of the lock button 68 which continuously biases the lock button radially relative to the valve stem and axis A.

The spring 76 may be a coil spring as shown, or it may be an integral spring, for example a leaf spring, formed in conjunction with one of the lock button 68 or the inner side wall of the button housing. In one embodiment a leaf spring 80 may be fabricated integrally on the second inner end of the lock button 68 to provide the radial bias. Alternatively, a spring tab 82 may be integrally molded on the inner wall of the button housing 66 against which the second end of the lock button 68 abuts after assembly. In either event, a spring device or assembly of other design that provides the necessary radial bias to the lock button 68 may also be used.

In another embodiment of the actuator shown in FIGS. 9C and D the button housing 66 may be provided with internal rails 67 formed adjacent the inner walls of the button housing 66 to slidably support the lock button 68 as it slides radially in the housing 66 relative to the axis A.

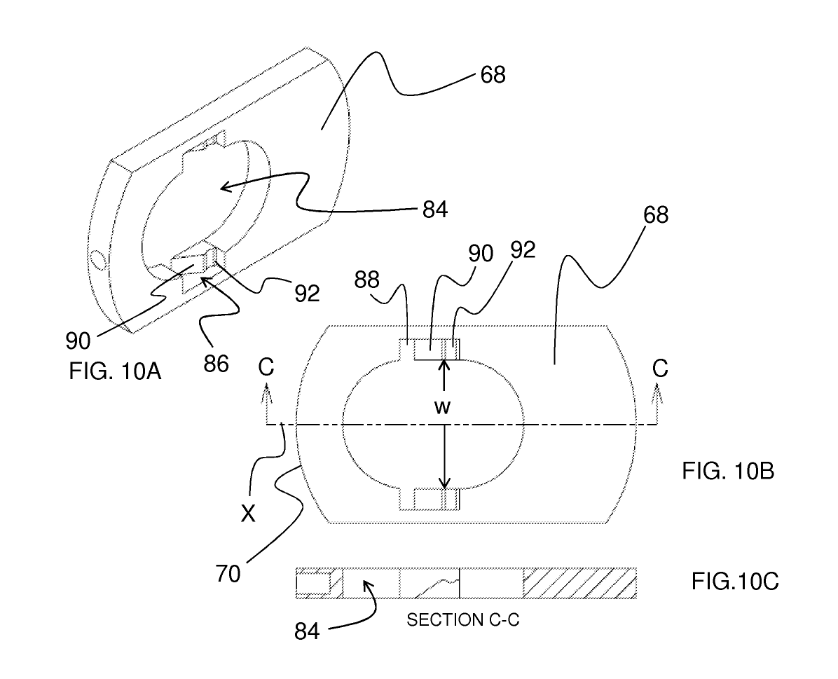

FIGS. 10A-C show the structure of the lock button 68 of the presently described embodiment. An actuator aperture 84 is formed in the lock button through which the actuator 64 is received. The aperture 84 is formed with an elongate or oblong shape along its main axis X such that the aperture 84 is longer in length along the main axis that the width w of the aperture 84. This elongate shape enables the lock button 68 to slide radially relative to the actuator 64, and the button housing 66, which are essentially radially fixed on the valve stem and mounting cup respectively. Thus, with the cam and ramp mechanism discussed below of the lock button 68 acting on the cam posts 26 of the actuator 64, the radial sliding and movement of the lock button 68 influences the actuator 64 between the actuated and unactuated positions shown in FIGS. 8A-D.

The cam and ramp mechanism formed in conjunction with the aperture 84 not only causes the actuator 64 to move axially along the valve stem axis A as the lock button 68 slides, but also locks the actuator 64 into the engaged position so that no manual force is necessary by the user to maintain the actuator 64 in the actuated position. A notch 86 is formed on opposing sides of the aperture 84, and each notch 86 consists of three different portions, a passage portion 88, a ramp portion 90 and a lock portion 92. The passage portion 88 in the notch 86 extends entirely through the notch 86 and wall of the lock button 68 creating a complete passage for the radially extending cam posts 26 to pass through.

When the actuator assembly 60 is in the nonactuated state with no manual force applied to any element of the assembly, the radial spring bias on the lock button 68 adjusts the lock button 68 into a position shown in FIGS. 8C-D wherein the cam posts 26 on the actuator 64 are vertically aligned with the respective passage portions 88 in the lock button 68. In this position, the actuator 64 is free to be influenced in the same manner as a traditional actuator button affixed to a valve stem. A user's axial actuation of the actuator 64 with their finger would directly open the valve against the bias of the valve stem without interference or other influence on or by the lock button 68 since the cam posts 26 on the actuator 64 would merely pass freely vertically, i.e. axially parallel with the valve stem axis, up and down through the passage portions 88 to toggle the valve on and off.

To lock the actuator 64 into the actuated or on position for continuous spray, the user would push radially on the exposed first end 69 of the lock button 68 which brings a free edge of the ramp portion 90 into engagement with a top portion of the cam post 26. As the lock button 68 is continuously slid radially relative to the actuator 64 the ramp 90 forces the cam posts 26 and hence the actuator 64 axially downwards relative to the valve stem thus actuating the valve. At the end of the ramp portion 90, the lock portion 92 awaits the entrance of the cam posts 26, as the user continues to slide the lock button 68. The lock portion 92 of each notch 86 is provided with a semi-circular receiving surface which is arranged to hold the respective cam posts 26 and the actuator 64 in the actuated position. As the button 68 is forced inwards by the user, the cam posts 26 move radially along the ramp portion 90 and past the end of the ramp portion 90 the posts 26 snap into the receiving surface of the lock portion 92 and the user may remove any force on the lock button 68 or actuator 64 and the valve will remain open for dispensing of product from the container through the valve, valve stem and out the actuator 64.

To release the assembly from the actuated position, the user need merely press down on the actuator 64 pushing the cam posts 26 out of contact with the receiving surfaces of the lock portion 92 thus enabling the radial spring bias between the inner wall 78 of the button housing 66 and the lock button 68 to push the lock button 68 radially back, or outward relative to the housing 66 towards the unactuated position with the end of the button 68 extending radially outward from the sidewall of the button housing 66 and aligning the passages with the cam posts 26. The user's release of downward axial pressure on the actuator 64 thus permits the actuator 64 to be biased axially upwards along the valve stem axis by the valve stem returning the actuator 64 to the nonactuated position.

It may also be arranged that the locked actuated position can be overcome by manual operation of the lock button 68, as opposed to the actuator 64 described above, being pushed inwards to force the cam posts 26 out of contact with the receiving surfaces. There may then be enough inherent bias in the radially biased spring to push the lock button 68 out of relative locked engagement with the cam posts 26 on the actuator 64, thus permitting the actuator 64 to be released upwards with valve stem to close the valve.

Since certain changes may be made in the above described improved continuous dispensing actuator assembly, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, we claim:

1. A continuous dispensing actuator assembly for a pressurized container comprising:
an actuator having a stem seat adapted to receive a valve stem of a valve, a discharge outlet in fluid communication with the stem seat and a cam post;
an overcap having a base portion for engagement with a mounting cup of the pressurized container on a lower surface and a lock mechanism cooperating with the overcap;
the lock mechanism having a cam surface adapted to engage the cam post to cause axial reciprocation of the actuator between an open continuous spray position and a closed position.

2. The continuous dispensing actuator assembly of claim 1 further comprising an orientation tab arranged on one of the actuator and overcap adapted to ensure that the actuator is rotationally fixed and axially moveable between the open and closed positions.

3. The continuous dispensing actuator assembly of claim 1, wherein the lock mechanism includes a lip for retaining the cam post.

4. The continuous dispensing actuator assembly of claim 1, wherein the lock mechanism is a slidable button extending through a slot in the overcap.

5. The continuous dispensing actuator assembly of claim 4, wherein the cam surface is formed on at least one of a bottom and interior surface of the slidable button.

6. The continuous dispensing actuator assembly of claim 1, wherein the cam surface defines a non-operative closed position of the valve and an operative position for retaining the actuator and valve in a compressed open position.

7. The continuous dispensing actuator assembly of claim 1, wherein the actuator comprises a pair of cam posts and the lock mechanism comprises a corresponding pair of cam surfaces.

8. The continuous dispensing actuator assembly of claim 6, wherein the pair of cam posts on the actuator are generally oppositely disposed.

9. A pressurized container including a continuous dispensing actuator assembly comprising:
an actuator having a stem seat for receiving a valve stem of a valve, a discharge outlet in fluid communication with the stem seat, a cam post and rotational control means for maintaining the actuator in a rotationally fixed position relative to the valve stem;
an overcap having an opening sized to allow passage of the actuator at least partially through the overcap; and
wherein a lock mechanism is provided with the overcap and includes a cam surface to engage the actuator cam post to influence the actuator in an axial manner relative to the valve stem.

10. The pressurized container including a continuous dispensing actuator assembly of claim 9, wherein the cam surface is formed on at least a portion of a lower surface of the lock mechanism.

11. The pressurized container including a continuous dispensing actuator assembly of claim 9, wherein the cam surface defines a non-operative closed position of the valve and an operative position for retaining the actuator and valve in a compressed open position.

12. The pressurized container including a continuous dispensing actuator assembly of claim 9, wherein the overcap further comprises a slot sized to allow passage of the cam post through the annular wall of a lock ring adaptor.

13. The pressurized container including a continuous dispensing actuator assembly of claim 9, further comprising a pressurized container including a mounting cup supporting the actuator assembly.

14. A continuous dispensing actuator assembly for a pressurized container comprising:
an actuator having a stem seat for receiving a valve stem of a valve, a discharge outlet in fluid communication with the stem seat, a cam post and control means for maintaining the actuator in a fixed position relative to the valve stem;
an overcap having a radial passage to allow passage of a lock button at least partially through the overcap and a spring tab biasing the lock button in a closed position, the lock button having an aperture with a cam surface to allow passage of the actuator at least partially through the lock button; and
wherein the cam surface of the lock button is adapted to engage the actuator cam post to reciprocate the actuator in an axial manner relative to the valve stem.

15. A continuous dispensing actuator assembly of claim 14, wherein the lock button is disengaged by compression of the actuator in an axial manner relative to the valve stem.

16. A method of dispensing pressurized fluids from a pressurized container comprising the steps of:
providing an actuator having a stem seat adapted to receive a valve stem of a valve, a discharge outlet in fluid communication with the stem seat and a cam post;
forming an overcap having a base portion for engagement with a mounting cup of the pressurized container on a lower surface and a passage for accepting a lock button;
inserting the lock button through the passage in the overcap, the lock button having an aperture and a cam surface;
inserting the actuator through the aperture of the lock button; and
actuating the lock button to engage the cam post to cause axial reciprocation of the actuator to an open continuous spray position.

17. The method of claim 16 further comprising the step of disengaging the lock button by compressing the actuator to cause axial reciprocation of the actuator to a closed position.
